(19) United States
(12) Patent Application Publication
(10) Pub. No.: US 2008/0097959 A1
(43) Pub. Date: Apr. 24, 2008

(54) SCALABLE XML FILTERING WITH BOTTOM UP PATH MATCHING AND ENCODED PATH JOINS

(75) Inventors: Songting Chen, San Jose, CA (US); Junichi Tatemura, Sunnyvale, CA (US); Wang-Pin Hsiung, Santa Clara, CA (US); Divyakant Agrawal, Goleta, CA (US); Kasim Selcuk Candan, Tempe, AZ (US); Hua-Gang Li, San Jose, CA (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 11/691,655

(22) Filed: Mar. 27, 2007

Related U.S. Application Data
(60) Provisional application No. 60/804,669, filed on Jun. 14, 2006.
(60) Provisional application No. 60/804,673, filed on Jun. 14, 2006.
(60) Provisional application No. 60/804,667, filed on Jun. 14, 2006.
(60) Provisional application No. 60/868,824, filed on Dec. 6, 2006.

(51) Int. Cl. G06F 17/30

(52) U.S. Cl. 707/2; 707/E17.017

(57) ABSTRACT

Systems and methods to provide two bottom up path matching solutions and one post processing solution for evaluating value predicates and tree pattern queries. The first path matching method triggers the matching whenever a leaf query step is seen and stores the prefix sub-matches in a cache for reuse. The second path matching method is an NFA (non-deterministic finite state automata) based solution through a post-order traversal of the XML document tree. The post processing method relies on a compact encoding the path results, which avoids redundant value predicate, join evaluations and any duplicate elimination, sort and grouping operations.

This application claims priority to Provisional Application Ser. Nos. 60/804,673 (filed on Jun. 14, 2006), 60/804,667 (filed on Jun. 14, 2006), 60/804,669 (filed on Jun. 14, 2006), and 60/868,824 (filed on Dec. 6, 2006), the contents of which are incorporated by reference.

### BACKGROUND

The invention relates to scalable XML filtering.

XML (Extensible Markup Language) is a tool for defining, validating, and sharing document formats. XML uses tags to distinguish document structures, and attributes to encode extra document information. An XML document is modeled as a nested structure of elements. The scope of an element is defined by its start-tag and end-tag. XML documents can be viewed as ordered tree structures where each tree node corresponds to document elements and edges represent direct (element->sub-element) relationships. The XML semi-structured data model has become the choice both in data and document management systems because of its capability of representing irregular data while keeping the data structure as much as it exists. Thus, XML has become the data model of many of the state-of-the-art technologies such as XML web services. The rich content and the flexible semi-structure of XML documents demand efficient support for complex declarative queries. Common XML query languages, such as XPath and XQuery, issue structural queries over the XML data. One common structural query is tree (twig) pattern query. Two sample tree pattern queries are shown in FIG. 1B over the example XML document tree in FIG. 1A. The “/” axis denotes the Parent-Child (PC) relationship, while the “//” axis denotes the Ancestor-Descendant (AD) relationship.

Today, most business-to-business communication is through XML-based messaging interfaces. XML message brokers provide various services, such as filtering, tracking, and routing, that enable processing and delivery of the message traffic in an enterprise context. In particular, XML message filtering systems are used for sifting through real-time messages to support publish/subscribe, real-time business data mining, accounting, and reporting requirements of enterprises.

An XML message filtering system continuously evaluates a given set of registered filter predicates on real-time message streams to identify the relevant data for higher-level processing. Thus, XML filtering problem is concerned with finding instances of a given, potentially large, set of patterns in a continuous stream of data trees (or XML messages). More specifically, if {x₁, x₂, . . . } denotes a stream of XML messages, where xi is i^{th} XML message in the stream, and {q₁, . . . , qₘ} is a set of filter predicates (described in an XML query language, such as XPath or XQuery) then an XML filtering system identifies (in real-time) (xᵢ, qⱼ, PTᵢⱼ) triplets, such that the message xᵢ satisfies the filter query qⱼ. Furthermore, the set PTᵢⱼ includes each instantiation of the query (referred to as matching tuples) in the message.

The XML filtering problem is related to, but different from, the more traditional stored XML data retrieval problem, where given a stored collection of XML data objects and a query, the system needs to identify those data instances which satisfy the given query. Since, in the case of the stored data retrieval problem, data collection does not arrive in real-time and since the contents of the database can be made accessible (through indexes and internal tables) in any appropriate order, XML query processing approaches concentrate on finding effective mechanisms for matching query strings to indexed data strings or indexing data paths and data elements to efficiently check structural relationships. In contrast, in XML filtering, data is available to the filtering mechanism in a streaming fashion, i.e. one node at a time, and in a fixed order. Since the data arrives continuously, it is essential that the filtering rate matches the data arrival rate. Therefore, instead of the data (which is transitionary) the collection of filter patterns themselves need to be indexed to enable real-time filtering.

Existing XML filtering schemes include YFilter, XTrie, XScan, and XQFU. Most of these techniques rely on finite state machine based approaches: they assume that the data tree is available one node at a time in document order (pre-order) and each data node causes a deterministic or nondeterministic state transition in the underlying finite state machine based representation of the filter patterns. The set of active states of the machine, then, corresponds to the potential sub-matches identified based on the data that have been observed. In general, for XML data sets with deep and recursive structures, the number of active states can be exponentially large. Furthermore, most of the states enumerated by these state-automata based approaches are redundant. To ensure correctness, however, all these states have to be collected and maintained until the corresponding data instance is eliminated from consideration.

In essence, these works evaluate the path queries top-down. The left side of FIG. 1B depicts the conceptual execution of a top-down non-deterministic finite state automaton over the sample path query. Here the shaded triangle represents the XML document tree. As can be seen, every document element will introduce a state-1 transition; every sub-element of a will introduce a state-3 transition; every sub-element of b will further introduce a state-5 transition. Such excessive number of transitions poses the potential bottleneck for any NFA-based solutions.

Once the path matches are found through the path matching engine, the post-processing phase is to handle the more complex XPath expressions. However, the generated path matches typically have high redundancies especially for the elements corresponding to the query nodes that are closer to the root query node. This consequently causes redundant post-processing upon them. For example, in FIG. 1A, the path matching engine first tries to match the path queries in a shared manner. There are 4 matches for //A//B//C that involve a1, namely, (a1, b1, c1), (a1, b1, c2), (a1, b2, c1) and (a1, b2, c2) 1. Then for Q1, the predicate “@id=1” is also evaluated 4 times during post-processing. This is rather undesirable since whether a1 satisfies the predicate can be determined in a single check. Clearly, similar issue arises during the processing of the tree pattern (twig) query Q2, where redundant join probes are evaluated.

### SUMMARY

In a first aspect, a method provides an adaptable path expression filter by indexing one or more registered pattern expressions with a linear size data structure; representing at least one root-to-leaf path with a runtime stack-based data structure (StackFab); and storing one or more prefix sub-matches in a cache for reuse.

Implementations of the first aspect may include one or more of the following. The method can filter path expressions of type P^{{//,//,*}}. The StackFab contains one stack per symbol. The StackFab is implemented based on one or more step commonalities between path expressions during a pre-order traversal of an XML document. One or more leaf steps in the path expressions can be used as trigger conditions. The method includes traversing back one or more links in the StackFab to compute individual path matches once the trigger conditions are detected. The method can also include clustered traversing back by exploiting suffix commonalities between path expressions. Repetitive traversals are avoided by caching results of a common prefix among one or more path expressions. The method also includes clustered traversing back by exploiting suffix commonalities between path expressions; avoiding repetitive traversals by caching a result of a common prefix among one or more path expressions; and performing early and late unfolding of a suffix based cluster.

In a second aspect, a method to filter one or more path expressions includes applying an NFA (non-deterministic finite state automata) to filter the one or more path expressions; performing a post-order traversal of an XML document tree; and exploiting one or more suffix commonalities among the one or more path expressions.

Implementations of the second aspect may include one or more of the following. The method can filter path expressions of type P^{{//,//*}}. A bottom up path matching can be done based on non-deterministic finite state automaton. The method includes performing shared (common document prefix) path matching through post-order document traversal. The method can also perform shared (multiple path expressions) path matching by exploiting the suffix commonalities between path expressions.

In a third aspect, a method to determine one or more compact path matches includes using a compact tree encoding scheme to represent one or more path matches for an XML document; and computing the compact encoding scheme when filtering the path expression using an NFA (non-deterministic finite state automata).

Implementations of the third aspect may include one or more of the following. The method can filter the path expression using an NFA (non-deterministic finite state automata) through a post-order traversal of an XML document tree. The method includes associating a PCTable and an ADTable with each document element, the document element having a list of tree encodings. Tree encodings in the PCTable and ADTable can be propagated to those of the parent element.

In a fourth aspect, a method to process a complex query using tree encoding includes filtering the tree pattern query; and processing the generalized tree pattern queries based on the tree encoding.

Implementations of the fourth aspect may include one or more of the following. The method can be used to filter tree pattern queries. A generalized-tree-pattern query containing a mixture of a binding node, a non-binding node and a group binding node can be processed. One or more value predicates over tree encodings can be evaluated. A merge join based method for evaluating path joins over tree encodings can be done. A top-down filtering of tree pattern queries with early termination can be performed. The query processing method of generalized tree pattern queries can be done top-down.

In sum, the system evaluates the path queries bottom up from the leaf query node to the root query node. For this, a stateless (by exploiting both prefix and suffix commonalities) and a stateful approach (by exploiting only suffix commonalities) are designed. Their main performance trade-off depends on the path selectivity. Next, a compact encoding is designed to compactly represent the path matches for the XML entire document. With this encoding scheme, the system efficiently evaluates the value-based predicates and path joins for tree pattern queries.

### BRIEF DESCRIPTION OF THE DRAWINGS

FIG. 1A-1C illustrate the operation of various adaptable path expression filters.

FIG. 2A shows one embodiment of a system to filter multiple XML queries.

FIG. 2B illustrates an exemplary AxisView for path expressions.

FIG. 3 shows an exemplary push process for a “*” stack.

FIG. 4(a) shows the stacks of an empty StackBranch corresponding to the AxisView of FIG. 2B.

FIG. 4(b) shows the state of StackBranch after a stream is observed.

FIG. 4(c), then, shows the StackBranch after the next tag, <c> has been observed in the stream.

FIG. 5 shows an exemplary pop algorithm.

FIG. 6 shows an exemplary trigger condition.

FIG. 7 shows the trigger phase operations performed for each object pushed into a stack.

FIGS. 8(a-d) illustrate an exemplary traversal process.

FIGS. 9A-9B show an exemplary traverse operation.

FIGS. 10(a)-10(b) show exemplary PRView and SFView data structures.

FIG. 11 shows a many to many relationship between prefix and suffix labels of filter statements.

FIG. 12 illustrates the use two different suffix label labels to place two assertions into separate clusters.

FIG. 13 shows suffix support for reduced filtering.

FIG. 14 illustrates an exemplary cache access pruning operation.

FIG. 15 shows late unfolding of suffix clusters with candidate assertion removal and branch pruning.

FIG. 16 illustrates the marking of candidate assertions for removal from consideration.

FIG. 17 depicts an NFA based bottom-up path matching algorithm.

FIG. 18 illustrates an exemplary propagateBoth procedure.

FIG. 19 describes a running example for processing the XML document of FIG. 1A based on the plan of FIG. 16.

FIG. 20 depicts one example of a TOP encoding scheme that captures an AD relationship between the elements that satisfy the same query node.

FIGS. 21-23 depict details how the TOP encoding scheme can be piggybacked into the path matching algorithm.

FIG. 24 shows how the results of path query can be compactly encoded.

FIG. 25 depicts the algorithm for predicate evaluation over the encoded path matches.

FIG. 26 shows matching SOTs of a root node N.

FIG. 27 shows exemplary details of multi-way join over encoded paths.

FIG. 28 shows an exemplary twig query.

FIG. 29 shows one example how the twig query in FIG. 28 can be filtered.

FIG. 30 depicts the details of the filtering algorithm.

FIG. 31 depicts the query processing algorithm for a single binding node.

FIG. 32-37 depicts various exemplary test results.

### DESCRIPTION

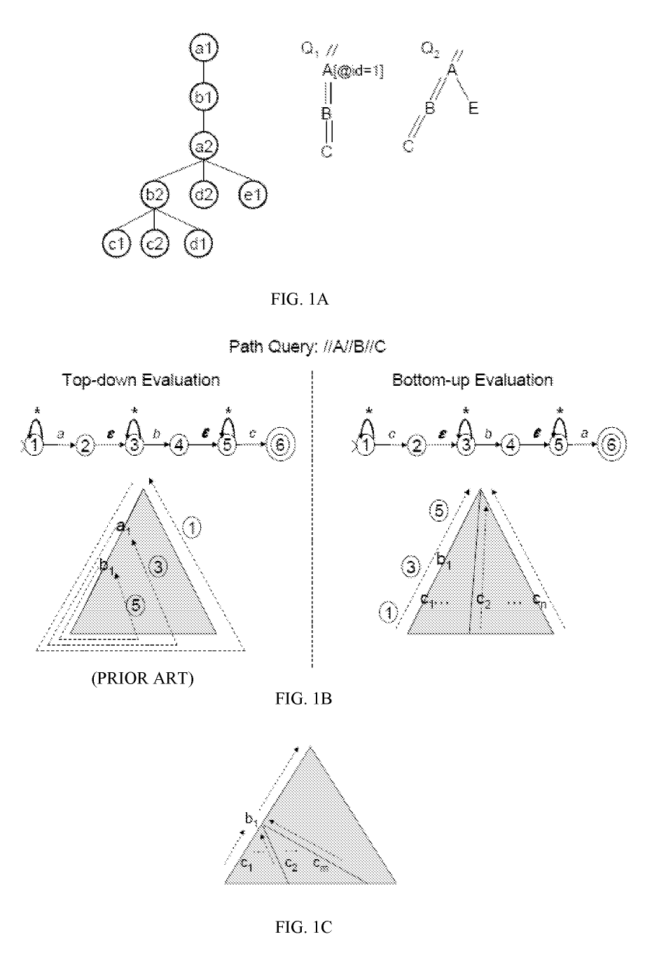

Unlike pattern matching over flat string, the scope of path matches over a tree structure is restricted to each document path. Hence the matching process also depends on how the tree is traversed. Based on this observation, a bottom-up path matching solution is designed specifically for the tree type of XML data to address the excessive Q-transitions problem. In contrast to the conventional technique shown in the left side of FIG. 1B, the right side of FIG. 1B intuitively illustrates one embodiment of the invention. As can be seen, only those document paths from any C element to the root could be a potential match. Hence, in general, the system can limit the number of document paths that need to be explored for path matching unless all the document leaves are the same C elements, which is quite unlikely in practice. Furthermore, the transitions is bounded by the document prefix path rather than the entire sub-tree. In the above example, the transitions of state-3 and state-5 are evaluated for each element in the prefix path as opposed to for each element in the sub-tree.

These paths from ci to root in FIG. 1B may share the common document prefix as shown in FIG. 1C. Unlike the top-down approach where the matching of common document prefix is naturally shared between different document paths, here special treatment is needed. As can be seen in FIG. 1C, when c1 is first visited, if the system were to evaluate the entire path from c1 to root, the common document prefix may have to be re-evaluated for each ci. The system utilizes two methods to address this issue. First is to cache the matching results from root to b1 for c1 such that other ci can re-use the matching results. Second is to delay the processing of the common document prefix until all the paths from ci to b1 have been processed, i.e., when the end-tag of b1 is visited. This naturally calls for a post-order traversal of the XML document, i.e., the order of end-tags in the XML streams.

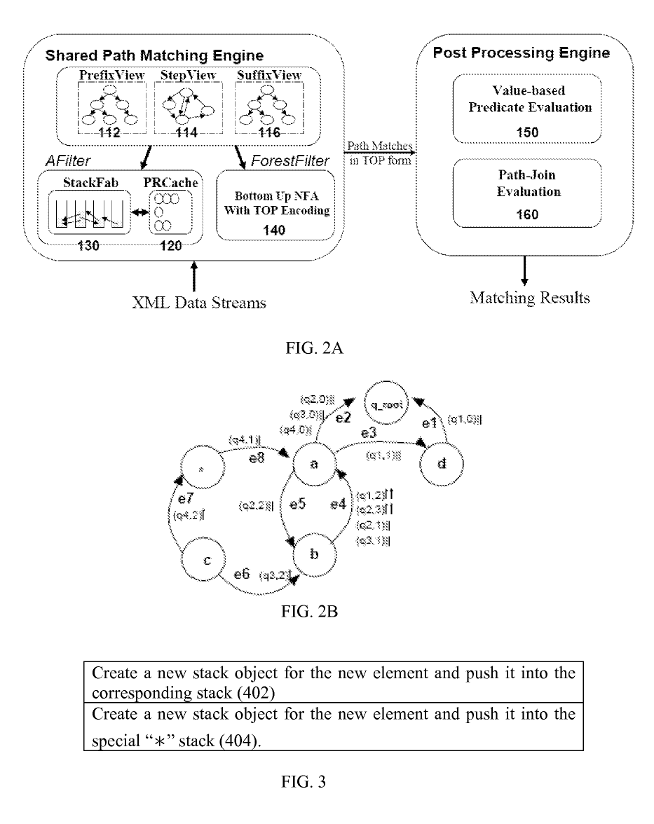

FIG. 2A shows one embodiment of a system to filter multiple XML queries. The system has two major components, a shared path matching engine and a post processing engine. The shared path matching engine is to match the path queries over the input XML streams. The post processing engine evaluates the value-based predicates and path joins over the matching paths. Multiple path expressions can be shared in terms of their common steps (AxisView 112), common prefix (PRView 114) and common suffix (SFView 116). Two alternatives are developed for processing these path expressions. The first method is the stateless approach, called AFilter, which utilizes a runtime data structure called StackBranch 120, (linear in the depth of the message tree) to represent the current root-to-element branch; and PRCache 130, which stores prefix sub-matches for re-use. As explained in more details later, this method filters path expression through pre-fix caching and suffix clustering. The second method, called ForestFilter, is a bottom up non-deterministic finite state automaton (NFA) that exploits the suffix clustering (Bottom up NFA 140).

The first stateless path matching method, AFilter, i.e., using StackBranch (130) and PRCache (120) is discussed. AxisView 112 is a directed graph capturing the query steps registered in the system. Each node in the graph corresponds to a label and each edge corresponds to a set of axis tests. Each edge is annotated with a set of axis assertions that need to be verified to identify matches. PRView 114 is an (optional) “trie” data structure which clusters path expressions based on the commonalities in their prefixes. This is used for enabling prefix-based sharing of sub-results across path expressions. SFView 116 is an (optional) “trie” data structure which clusters path expressions based on their overlapping suffixes. It is used for clustering the evaluation of the AxisView edges for better filtering performance. All three views are incrementally maintainable.

The AxisView data structure captures and clusters all axes of all filter expressions registered in the system in the form of a directed graph. The algorithm for creating the AxisView is as follows: If Q={q₁, . . . , qₘ} is a set of filter expressions and Σ={α₀ . . . αᵣ,}, where α₀=“q_root”, be the label alphabet composed of the element names in the filter expressions in Q. Let also Σ*=Σ*U {α*} be the alphabet extended with the wildcard symbol, α*=“*”. The corresponding AxisView, AV(Q)=(V, E, AN), structure is a labeled directed graph, with the following properties:

1) For each, αₖ [symbol] Σ*, V contains a node nₖ.

2) If there is an axis, “αₖ/α₁” or “αₖ//α₁”, in filter predicates in Q, then E contains an edge êₕ=<l,k> from n₁ to nₖ.

3) Each edge, êₕ, has an associated annotation, AN(êₕ); each annotation contains a set of assertions that, if verified, can be used to identify a filter result.

Let “αₖ/αₗ” or “αₖ//αₗ” be the s^{th} axis in a filter pattern, qⱼ. Furthermore, let êₕ=<1, k> be the edge from n₁ to nₖ. Then, the set of annotations associated with êₕ contains an assertion assertₕ [symbol] AN(êₕ), such that
if the axis is of the form “αₖ/αₗ” then
   if α₁ is the last label test in the filter pattern, qⱼ, then assertₕ is “(qⱼ, s)^{↑}” else assertₕ is “(qⱼ, s)^{|}”
if the axis is of the form “αₖ//αₗ” then
   if α₁ is the last label test in the filter pattern, qⱼ, then assertₕ is “(qⱼ, s)^{↑↑}” else assertₕ is “(qⱼ, s)^{∥}”

The two symbols, ↑ and ↑↑, in the assertions denote the trigger conditions through parent/child and ancestor/descendent axes respectively. For example, FIG. 2B illustrates AxisView for path expressions {q₁=//d//a//b, q₂=//a//b//a//b, q₃=//a//b/c, q₄=/a/*/c}. The AxisView data structure resembles a deterministic FSM; however, the data structure represents the filter axes in a compact manner. Unlike state machine-based schemes (such as YFilter), AxisView is not traversed in a forward manner to generate candidate states. Instead, AxisView acts as a blueprint for the construction of the run-time data structure, StackBranch, which is traversed in the reverse direction and only when a trigger condition is observed. In fact, if no trigger conditions are observed in the XML data stream, it is possible that AxisView will not be traversed at all.

StackBranch, SB(Q)={Sₖ|αₖ [symbol] Σ*} of Q is a set of stacks corresponding to the nodes of the AxisView, AV(Q)=(V, E, AN). StackBranch contains one stack for each node in the AxisView; i.e., only one stack for each symbol in the label alphabet. Stacks are also included for the query root (q_root) and the “*” wildcard symbol. At any given point in time, StackBranch contains one stack for each node in the AxisView and one stack exists for each symbol in the label alphabet.

For the XML message stream, a well-formed XML message model is used where each message in the stream is an ordered tree of elements. The beginning of each element is marked with a start tag and its end is marked with an end tag; all the descendant elements start and end between these two tags. If x is an XML message, then x[i] denotes the i^{th} element seen during the document-order (pre-order) traversal of x. The label, a1=tag(x[i]) [symbol] Σ denotes the label of this element and depth(x[i]) is its depth in the message. An XML stream is, then, a sequence {x₁, x₂, . . . } of XML messages.

The runtime state of StackBranch is affected when a start tag of an XML element is encountered or when an end tag is seen. Each time a start tag is observed in the data stream, a new stack object is created and is pushed into the stack corresponding to the element label. Each stack object contains the index of the element, its depth in the message, and as many pointers as the out-degree of the corresponding node in the AxisView data structure. Each pointer corresponds to an edge in the AxisView and points to the topmost object in the stack corresponding to the destination of the edge. If any of the queries also contain the “*” wildcard symbol, then for each new stack object inserted into its own stack, a corresponding stack object is created and inserted into the special S, stack. The process creates a new stack object for the new element and pushes the object into the corresponding stack. The push step is called each time an open tag is seen.

FIG. 3 shows an exemplary push process. First, the process creates a new stack object for the new element and pushes it into the corresponding stack (402). Next, the process creates a new stack object for the new element and pushes it into the special “*” stack (404). One implementation of the push algorithm is shown below:

Push: (When a start tag, < α₁ >, for x[i] is seen in the input stream)

/*

| | | Create a new stack object for the new element and push it |
|---|---|---|
| | | into the corresponding stack ... Let t denote the number of |
| | | outgoing edges of node n₁ (corresponding to label α₁) in |
| | | the AxisView data structure.*/ |
| at | 1. | Create an object o of the form |

o = <i, depth(x[i]), (ptrₛ, ...ptrₜ))

| 2. | If the h^{th} edge <l, k> of node n₁ points to node nₖ, then ptrₖ |
|---|---|
| | will point to the topmost element of stack Sₖ. If Sₖ is empty, |
| | then ptrₖ = ⊥ |
| 3. | push o into stack Sₗ. |

/* Create a new stack object for the

| | new element and push it into the special “*” stack ......Let |
|---|---|
| | r denote the number of outgoing edges of the special node |
| | n* corresponding to the * wildcard*/ |
| 4. | Create an object o of the form |

o = <i, depth(x[I]), <ptrᵢ, ...ptrᵣ>>

| 5. | If the h^{th} edge <l, k> of node n* points to node nₖ, then |
|---|---|
| | ptrₖ will point to the topmost (non “i”) element of stack Sₖ. If |
| | Sₖ is empty, then ptrₖ = ⊥ |
| 6. | push o into stack S*. |

FIG. 4(a) shows the stacks of an empty StackBranch corresponding to the AxisView and FIG. 2B. There is one stack per label symbol (independent of the number ofjlter statements). FIG. 4(b) shows the state of StackBranch after the stream <a><d><a><b> is observed. FIG. 4(c), then, shows the StackBranch after the next tag, <c> has been observed in the stream. To illustrate the push operation, when <c> is observed in the data, a new stack object q is created an inserted into the S stack. This new stack object has two out-going pointers, corresponding to the edges ê₆ and ê₇ in the AxisView (FIG. 2B). These pointers point to the topmost objects of the destination stacks. Then, a new stack object, c₁*, (again corresponding to <c>) is created and pushed into the S* stack. This object has a pointer corresponding to edge ê₈, pointing the topmost object in S_{α}. Stack Sq_root always contains a single object. The special stack for “*”, on the other hand, contains one stack object for every element observed on the current root-to-node branch. When the end tag of an element is seen, the corresponding stack object is popped (along with its pointers) from the data structure.

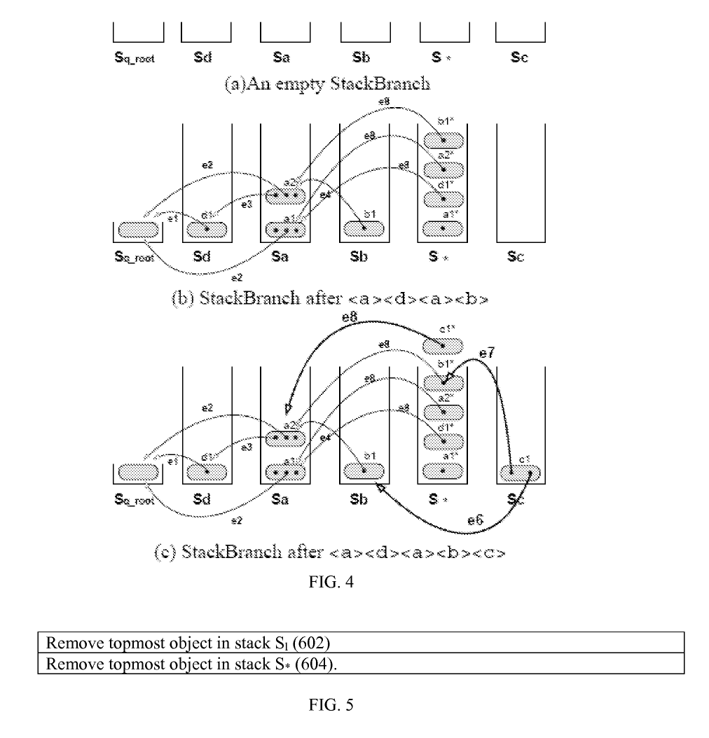

The pop algorithm is shown in FIG. 5. When a stop tag for x[i] is seen in the input stream), the process removes and eliminates the topmost object in stack S₁ (602). Next, the process removes and eliminates the topmost object in stack S* (604). The pop step is executed each time a close tag is seen in the stream. An exemplary pseudo-code for the pop algorithm is shown below:

Pop: (When a stop tag, < /α₁ >, for x[i] is seen in the input stream)

1. Remove and eliminate the topmost object in stack Sₗ.
2. Remove and eliminate the topmost object in stack S*.

As an example of the pop operation, after seeing the data stream <a><d><a><b><c> and the end tag </c> is encountered, StackBranch reverts back to its state in FIG. 4(b) from its state in FIG. 4(c).

As opposed to the finite automata based systems which traverse the state automata as they consume the input stream, AxisView and StackBranch structures are not traversed until a trigger condition is observed, benefiting from the generally more stringent selectivity in the leaves of XML data.

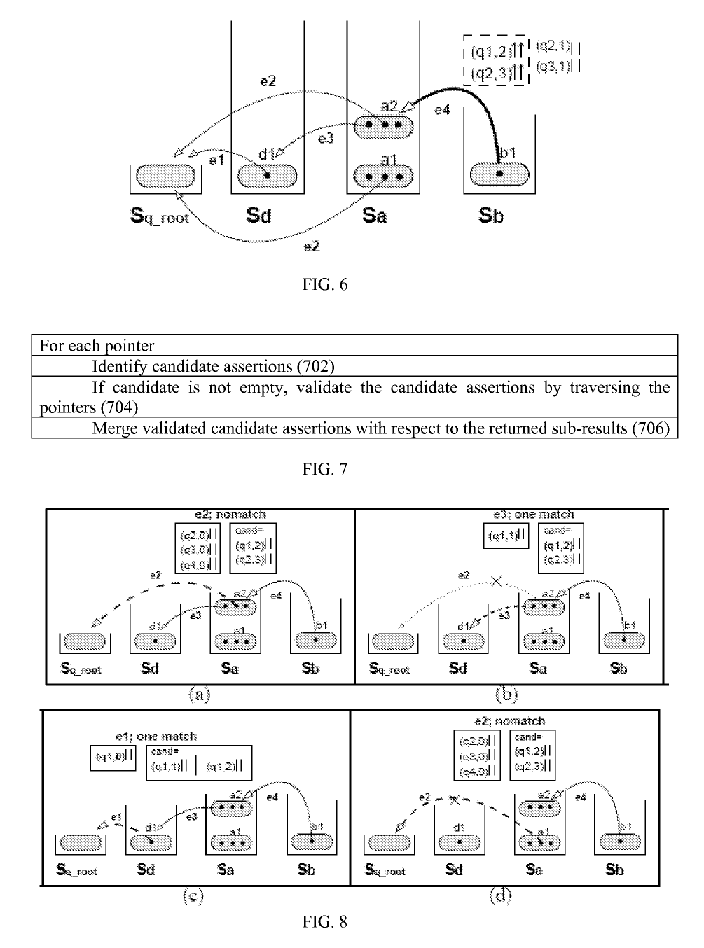

FIG. 6 shows an exemplary trigger condition where the <b> tag seen in the data triggers two assertions, (q₁, 2)^{↑↑} for query q₁=//d//a//b and (q₂, 3)^{↑↑} for q₂=//a//b//a//b. To simplify, only the relevant stacks are shown.

In FIG. 6, the stack object b₁ corresponding to the <b> open tag is pushed into the stack S_{b}. The AxisView edge e4, corresponding to the outgoing pointer, has a total of four assertions: (q₁, 2)^{↑↑}, (q₂,3)^{↑↑}, (q₂,1)^{∥}, and (q₃, 1)^{∥}. Two of these, (q₁, 2) for filter q₁=//d//a//b and (q₂,3)^{↑↑} for q₂=//a//b//a//b, are trigger assertions. Although the path expression q₂=//a//b//a//b has two a//b, only the last (leaf) label test is triggered.

Once trigger assertions are identified, the system needs to verify whether these assertions correspond to any actual matches or not. In some cases, it is easy to deduce that trigger assertions are not promising. For instance, for a filter expression to have a match there must be at least one pointer between all the relevant stacks. Also, the number of label tests in the filter query should be less than or equal to the depth of data. If these conditions do not hold, there can not be any matches. These pruning conditions can be implemented efficiently and can be useful, especially if the leaves have less stringent selectivity than earlier label tests in a given filter query. If an assertion is not pruned, then the StackBranch pointers have to be followed (or traversed) to identify whether there are actual matching path expressions.

FIG. 7 shows the trigger phase operations performed for each object pushed into stack S₁. In this process, for each pointer, the process performs the following operations. First, the process identifies candidate assertions (702). If the candidate is not empty, validate the candidate assertions by traversing the pointers (704). The process then merges validated candidate assertions with respect to the returned sub-results (706). The pseudo-code for the trigger phase operation is as follows:

TriggerCheck: (Far an object o = (<i, depth(x[i]), <ptr₁...,ptrₛ)) pu-
shed into stack S₁):

1. tempresult = [symbol]
2. result = [symbol]
3. For each ptrₕ of o

/* Identify the candidate assertions*/

| | |
|---|---|
| (a) | cand = |

| | |
|---|---|
| {(q, s)^{\|} \| (q, s)^{†} ∈ AN(êₕ) [symbol] [symbol] prune(q)} | ∪ |
| {(q, s)^{\|\|}\| (q, s)^{††}∈ AN(êₕ) [symbol] [symbol] prune(q)} | |
| /* ...if cand is not empty validate the candidate | |
| assertions by traversing the pointers*/ | |

| | |
|---|---|
| (b) | if cand ≠ [symbol] |

i. tempresult = tempresult

traverse(cand, depth(x[i]), ptrₕ)

/* Final-

| | ly, merge the validated candidate assertions with |
|---|---|
| | the returned subresults. This step will be referred |
| | to as expand(result, o, tempresult) in the rest |
| | of the paper*/ |
| (c) | for all r ∈ tempresult |

i. let [(q, s}, oᵤ] be the head of r
ii. result = result ∪ <[(q, s + 1), o]|r)

4. Repeat the same process for o pushed into stack S*

The processing of all non-pruned candidate assertions is performed by traversing the pointer outgoing from the triggering stack object (step 3b). The traversal operation will return the sub-results for all validated candidate assertions. These validated assertions will then be expanded by mapping with the matching sub-results (Step 3c) and will be returned as results.

FIG. 6 shows the two candidate assertions triggered due to the <b> tag seen in the data. Since the pointer associated with the corresponding stack object, b₁, points to the object a₂ in stack Sₐ, verification of this trigger will require the system to traverse the corresponding pointer towards the stack object a₂. The pointer is traversed only once (in a grouped manner) for both candidates, (q₁,2)^{∥} and (q₂,3)^{∥}, asserted by the trigger.

The stack object a₂, on the other hand, has two outgoing pointers, one pointing to stack S_{d} and the other to S_{q}_{_{—}}ᵣₒₒₜ. These two pointer are associated with AxisView edges, ê₃ and ê₂, respectively; therefore whether these pointers will be traversed or not will depend on whether the local assertions associated with these two edges are compatible with the two candidate assertions, (q₁,2)^{∥} and (q₂,3)^{∥}. A candidate assertion assertᵢ=(qᵢ, sᵢ) is compatible with a local assertion assertⱼ=(qⱼ, sⱼ) if qᵢ=qⱼ and sᵢ=sᵢ+1.

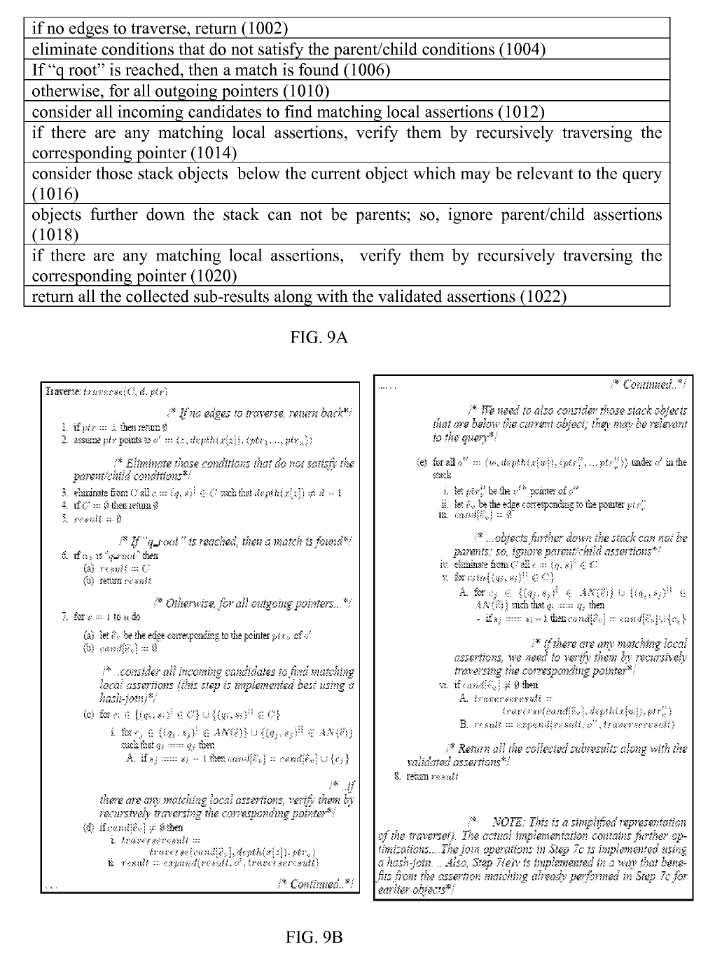

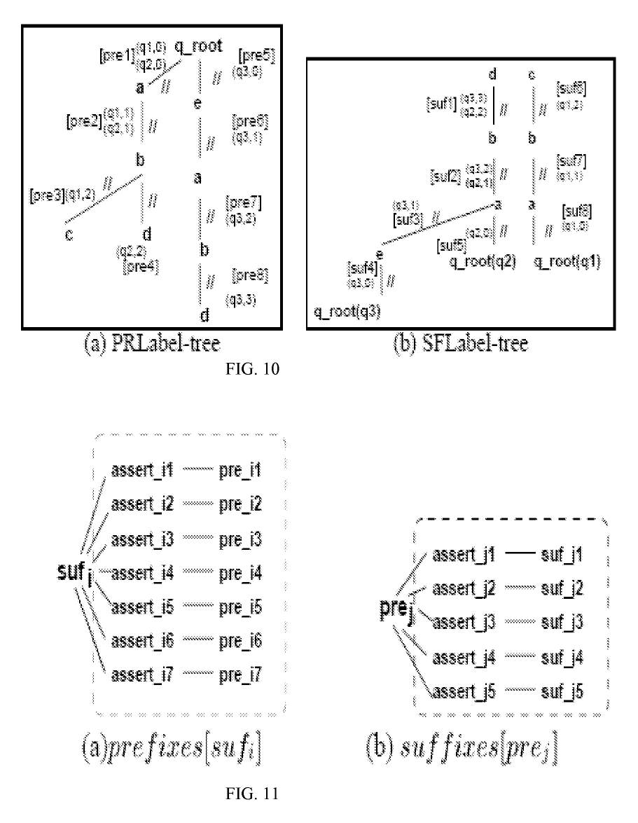

FIGS. 8(a-d) illustrate the traversal process: FIGS. 8(a-b) show a grouped verification of the candidate assertions associated with the two outgoing pointers of q₂, FIG. 9(c) shows a successful match, and FIG. 8(d) shows a no match case. First the pointer associated with edge ê₂, from a₂ to qᵣₒₒₜ, is considered (FIG. 8(a)). In this case, the only common filter query between the sets of candidate and local assertions is q₂. However, the required steps of the trigger assertion and the local assertion (2 and 0 respectively) do not match; naturally, a query step 2 can only be preceded by a query step 1. Therefore, this pointer does not lead into further traversals.

In FIG. 8(b), the outgoing pointer associated with edge ê₃, from a₂ to d₁, is considered. However, a common query, q₁, which has matching assertions (steps 1 and 2, respectively). Therefore, there is a possible match and the outgoing pointers associated with d₁ should be further traversed.

In FIG. 8(c), the outgoing edge, ê₁ from d₁ is considered. In this case, the candidate (q₁, 1) matches the local assertion (q₁, 0). Therefore, the pointer can be traversed to its destination, qᵣₒₒₜ. Since the root is reached, this identifies a match for filter expression, q₁. The match consists of stack objects, d₁, a₂, and b₁.

In FIG. 8(d), since the stack based representation guarantees that any stack object under a₂ in the stack Sₐ will also be an ancestor of b₁ and since the candidate assertion being checked for ê₄ is an ancestor/descendent axis, the system examines further down the stack to see if there are any further potential matches. In this example, the Sa stack contains the stack object a1 under a2; therefore, a1 needs to be considered. In this case, a1 only has one single outgoing pointer, corresponding to the edge ê₂; however, as before, the local filter conditions of ê₂ do not match the incoming candidates. Hence, this object can not lead into further matches.

FIG. 9A shows an exemplary traverse operation. The process first checks if there are no edges to traverse, and if so return (1002). If there is an edge to traverse, the process eliminates conditions that do not satisfy the parent/child conditions (1004). If a qᵣₒₒₜ is reached, then a match is found (1006) and otherwise, for all outgoing pointers (1010), the process considers all incoming candidates to find matching local assertions (1012). If there are any matching local assertions, the process verifies them by recursively traversing the corresponding pointer (1014). The process also considers stack objects below the current object which may be relevant to the query (1016). The objects further down the stack can not be parents; so, ignore parent/child assertions (1018). If there are any matching local assertions, they are verified by recursively traversing the corresponding pointer (1020). The process then returns all the collected subresults along with the validated assertions (1022). FIG. 9B depicts the corresponding pseudo-code.

Next, the application of PRCache (120 in FIG. 2A) is to provide prefix-caching support for eliminating redundant pointer traversals, i.e., steps 7(d)i and 7(e)vi of the traverse algorithm in FIG. 9B. In these steps, for a given set (cand[êᵥ]) of candidate assertions, the corresponding pointer, ptr, is (recursively) traversed to verify the assertions and collect possible sub-matches. As noted earlier, for a given candidate assertion, traversal of a pointer can either be successful, i.e., can lead into one or more (sub) matches, or may fail to provide any results.

If the same stack object is visited more than once during the filtering of an XML document (for example due to similar trigger conditions observed in the data), then it is possible that traversals originating from this object will repeatedly try to validate the same candidate assertions. This is wasteful: since stacks grow from root to the leaves in a monotonic fashion, it is straightforward to see that for a given stack object, repeated evaluations of the same candidate assertion will always lead to the same result. Therefore, to avoid repeated traversals of the pointers in StackBranch for the same assertions, PrefixCache caches the success or failure of the candidate assertions associated with each traversed pointer (along with the results obtained during the first ever traversal of this pointer). This enables future traversals involving the same assertions to be resolved through an efficient table lookup.

Repeated traversals of the same step of the same filter expression is especially common in (a) tree structured data, where a shared portion of the data needs to be considered for multiple XML data branches or (b) in recursive data with repeated element names which can trigger the same filter multiple times. Given a pointer, ptr, and an assertion, assert, associated with this pointer, PrRCache caches the traverse result, returned in Steps 7(d)i and 7(e)vi of the Traverse algorithm (in FIG. 9B) for the <assert, ptr> pair. Thus, next time the same assertion needs to be validated through the same pointer, the algorithm simply returns the corresponding matches from the PRCache; in other words, each prefix of each query is discovered only once.

This loosely-coupled memory structure enables the system to scale to multiple path expressions. The entries in PRCache are then hashed in the available memory space: unlike the existing mechanisms, if the such a way that query steps sharing the same prefix can also share cache storage space is limited, this method can completely eliminate cached results the use of PRCache or can use cache replacement policies (such as LRU) to keep an upper-bound on the number of cached prefixes, maximizing the utilization of the cache.

A second and (in terms of memory) cheaper caching alternative is to cache only the failed verifications (i.e., assertions with empty matches in traverse result). In this approach, since the positive results are not cached, the same sub-matches may be identified multiple times. However, it eliminates repeated fail traverses and since positive results are not cached, this approach has a lower (linear in the number of query steps) cache storage demand.

A cached result for an assertion assert₁=(q₁, s₁) can be used for another assertion assert₂=(q₂, s₂) if the system can insure that assert₁ and assert₂ have identical intermediate results. In other words, prefix-commonalities across filter statements can be exploited for improving the utilization of the PRCache entries. The system exploits prefix-commonalities by constructing a PRView (trie) data structure for identifying common prefixes across multiple path expressions. The entries in PRCache are then hashed such that query steps sharing the same prefix can also share cached results.

A Prefix Sharing example is discussed next with the following three filter patterns: q₁=//a//b//c, q₂=//a//b//d, q₃=//e//a//b//d. FIG. 10(a) depicts the prefix clustering of individual query steps.—Any assertions clustered under the same prefix ID in FIG. 10(a) can be cached under the same cache index. In this example, pairs (q₁, 0)-(q₂, 0) and (q₁, 1)-(q₂, 1), of assertions can be cached under the same prefixes, pre₁ and pre₂, respectively.

Prefix caching is useful in eliminating redundant traversals of the StackBranch pointers. However, even when such redundant traversals are eliminated, the cost of the Step 7c of the traversal algorithm (FIG. 9B), where candidate assertions are matched against the local assertions associated with the outgoing pointers, can be high.

As discussed earlier, StackBranch implements this step through a hash-join mechanism; thus, the cost of the operation is linear in the number of input candidate assertions that need to be matched. Reducing the number of candidate assertions would also reduce the time spent at the Step 7c of the traversal algorithm. Since traversals of the StackBranch are from the query leaves towards the query root, clustering assertions in terms of the shared suffixes would reduce the number of candidate assertions to be considered.

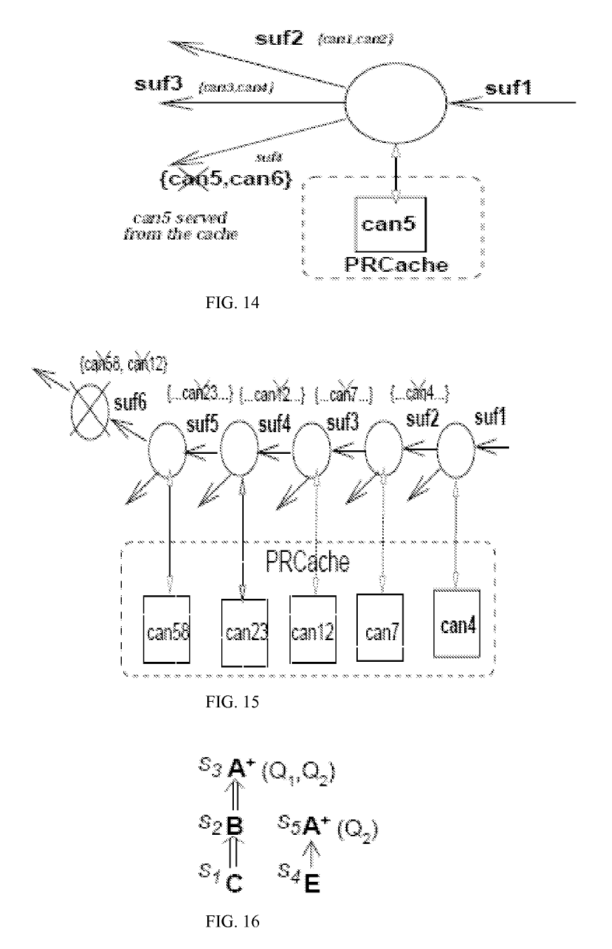

In an example of suffix sharing, the following filter statements share a common suffix (//a//b): q₁=//a//b, q₂=//a//b//a//b, q₃=//c//a//b. The corresponding SFView structure of FIG. 13(a) captures the suffix overlap. The original AxisView data structure, shown in FIG. 13(b), does not capture the suffix commonality (//a//b) across the three filter statements. The edge ê₄ in the AxisView triggers each of these three queries independently. A suffix-compressed AxisView reduces the amount of triggering and the traversals by clustering the shared suffixes in the AxisView, as shown in FIG. 14(c). In this suffix-compressed AxisView example, there is one trigger associated with edge ê₄ which clusters all three queries.

In the suffix-compressed AxisView, assertions are not made in terms of query IDs and steps, but in terms of edge IDs in the SFView tree. The StackBranch is traversed towards the qᵣₒₒₜ in a suffix clustered manner: matching of the candidate assertions and the local assertions (to decide which pointers to traverse for which assertions) is performed by checking if two corresponding edges are neighbors in the SFView tree or not. Once the qᵣₒₒₜ is reached and the matches are being compiled by tracing the matching results back (Steps 7(d)ii, 7(e)viB of the traverse algorithm in FIG. 9B), the individual assertions clustered under the successful suffix labels are used to expand sub-matches to identify the individual results.

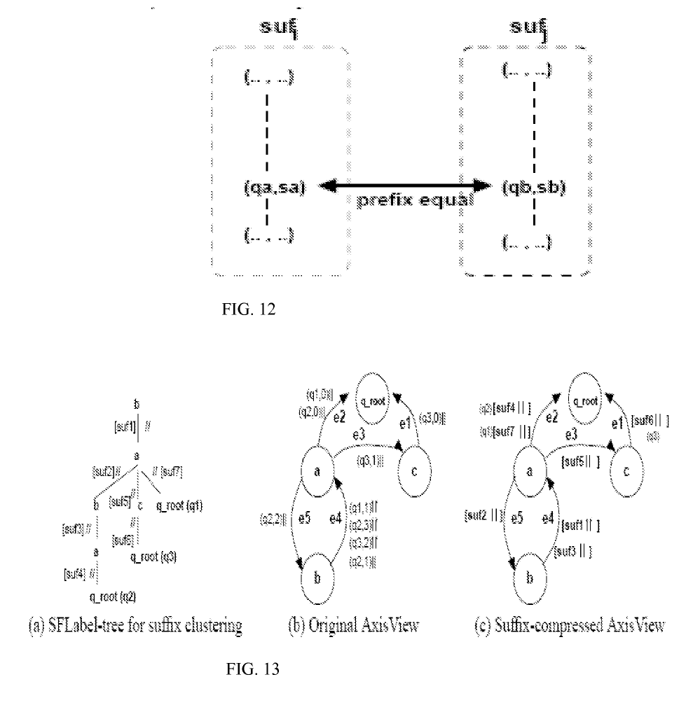

In FIG. 12, although the two assertions, (qa, sa) and (qb, sb), share the same prefix, two different suffix label labels, sufᵢ and sufⱼ, place these two assertions into separate clusters. Thus, if in Axisview, assertions are clustered under suffixes, then these two assertions can not benefit from each others' prefix caches.

Next, Prefix-Based Caching with Suffix-Compression is discussed. A label in a suffix-compressed AxisView clusters suffixes of the filter patterns, whereas PRCache caches intermediary results based on the common prefixes of the filters. As shown in FIG. 11, there is a many to many relationship between prefix and suffix labels of filter statements. Unfortunately, suffixes and prefixes are not always compatible and suffix-based clustering can prevent prefix-based caching opportunities. In particular, some of the prefix commonalities in filter statements will be hidden by suffix labels (FIG. 12). This reduces the utilization rate of the cache.

In another example that compares Suffix sharing against Prefix Sharing, the following three filter statements first considered in FIG. 10: q₁=//a//b//c, q₂=//a//b//d, q₃=//e//a//b//d. It is easy to see that the prefixes (//a//b) of filter statements q1 and q2 overlap, whereas the suffixes (//a//b//d) of q₂ and q₃ are also identical. The corresponding PRView and SFView data structures are shown in FIGS. 10(a) and 10(b), respectively. This leads to a conflict: for prefix sharing, (q₂, 1) needs to be able to access the cached results of (q₁, 1); on the other hand, to benefit from suffix clustering, (q₂, 1) needs to be clustered with (q₃,2), under the suffix label, suf₂. Thus, benefiting from prefix caching, while also exploiting suffix clustering, requires unfolding (or unclustering) of suffix-based clusters as needed. There are two unfolding alternatives, early and late unfolding.

FIG. 13 shows suffix support for reduced filtering (q₁=//a//b, q₂=//a//b//a//b, and q₃=//c//a//b). FIG. 14 shows early unfolding of suffix clusters: since can5 can be served from the cache, the corresponding cluster with the suffix label, suf₄, is unfolded; the corresponding pointer will be traversed in an unclustered manner (while the unaffected pointers continue to be traversed in a suffix-compressed manner with suffix labels, suf₂ and suf₃), while FIG. 15 shows late unfolding of suffix clusters, with candidate assertion removal and branch pruning.

As to Early Unfolding of Suffix Clusters, during the backward traversal of the StackBranch, the early unfolding mechanism un-clusters a suffix-label as soon as the system determines that one of the candidate assertions contained in a suffix-based cluster can be delivered from the cache. If during the pointer traversal step, a candidate assertion, (qⱼ, sⱼ), clustered under the suffix label, sufᵢ, is identified that can benefit from a result already in PRCache. In the early unfolding approach, the suffix label, sufᵢ, will be immediately unfolded and all the candidate assertions clustered under sufᵢ will be further verified individually.

FIG. 14 illustrates the early unfolding process with an example. If prefix caching is not used, the incoming suffix label sufᵢ will result in traversals of suffix labels, suf₂,suf₃ and suf₄, on three outgoing pointers. If the sum label suf₄ clusters two candidate assertions, can₅ and can₆ and the assertion can₅ can be served from the cache. In this case, to benefit from the cached results, the early unfolding mechanism would stop traversing the pointer corresponding to suf₄ in the suffix domain. Instead, it would traverse the pointer for the individual non-cached assertion (can₆ in this example). The pointers that can not benefit from the cache will continue to be traversed in a suffix clustered manner (suf₂ and suf₃).

While PRView and SFView data structures are constructed, prefix IDs are associated with the suffix labels (FIG. 11). When an assertion with a given prefix ID, preⱼ is cached in PRCache, an unfold[sufᵢ] bit for each suffix label, sufᵢ E suf fixes[preⱼ] is set (FIG. 11(b)). If a suffix label with a set unfold bit needs to be traversed, that suffix label will be immediately unclustered and the individual assertions are traversed independently.

Next, late unfolding of suffix clusters is discussed. Unfolding has an associated cost in terms of the lost assertion clustering opportunities. In cases where (a) suffix clusters are large, but (b) the prefix cache hit rate is low (i.e., when only a few candidate assertions per suffix cluster can actually be served from the prefix cache), early unfolding can cause unnecessary performance degradations. In such cases, it may be more advantageous to delay the unfolding of suffix clusters.

An example of late unfolding will be discussed next with reference to FIG. 15, where the suffix label suf₂ contains a candidate assertion can₄ which can be served from the cache early in the traversal process. In this case, early unfolding would require unfolding of all assertions clustered under the label suf₂. However, if suf₂ is unfolded at this sage, no subsequent step can be performed in the suffix clustered domain.

In contrast, late unfolding refrains from immediately un-clustering the set of candidate assertions under suf₂. While can₄ is served locally from the cache, the edge corresponding to the sum-based label suf₂ continues to be traversed using the sum label, instead of being traversed in terms of the individual assertions.

The challenge with such a delayed (or late) unfolding mechanism, however, is to ensure that cluster domain traversal does not cause redundant work for the already cached result. In the above example, since can₄ will eventually be served from the cache, this assertion should be removed from further consideration to prevent redundant work: in other words, the semantics of the suffix-label, suf₂, needs to be modified to exclude can₄ (illustrated with a cross on can₄ in FIG. 15). Thus, when an assertion with a given prefix is cached in PRCache, a remove[sufᵢ] [preⱼ] bit is set for each suffix label sufᵢ E suf fixes[preⱼ] (FIG. 10(b) illustrates suffixes[preⱼ])

Next, the process for pruning redundant prefix cache accesses will be discussed. If an assertion can be served from the cache, its prefixes do not need to be served from their own caches. Therefore, if an assertion is marked for removal from its suffix cluster, its prefixes should also be removed from their corresponding suffix-labels.

An example of pruning cache accesses is illustrated in FIG. 14. If candidate assertions can₇, can₁₂, can₂₃, and can₅₈, are all prefixes of the candidate assertion, while can₄ is removed from consideration, the cache will not be accessed for such non-maximal prefixes.

When a suffix label, sufᵢ is traversed, each preⱼ such that remove[sufᵢ] [preⱼ] is being set, is also inserted into a prune set. This is achieved by setting a prunecache[preⱼ] bit. If preₖ is a prefix of preⱼ, then remove[sufᵢ][preⱼ]->remove[sufᵢ][preₖ], and prunecache[preⱼ]->prunecache[preₖ]

This is used for pruning non-maximal prefixes of removed prefix labels from further consideration. For pruning redundant traversals, under late unfolding, if all candidates clustered under a suffix label are removed (i.e., can be served from the cache), the corresponding pointer does not need to be further traversed. For example, in FIG. 16, suf₆ clusters only two candidate assertions, can₅₈ and can₁₂, both of which have been marked for removal from consideration. Therefore, the corresponding pointer does not need to be further traversed.

Pruning condition for a suffix, sufⱼ, is checked by considering whether V preⱼj E prefixes[sufᵢ], the removal bit remove [sufᵢ] [preⱼ] has been set or not ((FIG. 12(a)) illustrates prefixes [sufᵢ]).

The performance of the late unfolding approach depends on how easy it is to look into the clusters for checking (a) if any of the clustered assertions can be sewed from the cache, (b) if any of such assertions are in the removal list, or (c) if each candidate clustered under a suffix label is a prefix of another one which has already been removed.

The cost of checking if any of the clustered assertions can be served from the cache is the same an early unfolding scheme would have to pay to use the PRCache. On the other hand, as described above, sharing of the removal bits between prefixes requires the propagation of the removed prefixes along the traversal path using the prunecache[prefixID] bits. As evidenced in the next section, despite this overhead, late unfolding provides the best of both prefi caching and suffix-clustering approaches, and thus significantly outperforms all alternatives.

Next, the second path matching method in FIG. 2A, ForestFilter, i.e., using bottom-up non-deterministic finite state automaton (NFA) is discussed. Unlike the first method, this approach only exploits the common suffix sharing among multiple path queries. For the two queries in FIG. 1A, the shared suffix plan, i.e., SFView is depicted in FIG. 16, where Si is the identity for each suffix node and “+” denotes that it is root node of some queries. For each suffix node Si in the shared plan, PCParent(Si, L) denotes Si's parent with PC (parent/child) axis, whose label is L, while ADParent(Si, L) denotes Si's parent with AD (ancestor/descendant) axis, whose label is L. If Si is not parent of any other node, the system calls Si the leaf suffix node. In FIG. 4, ADParent(S1,B)=S2, PCParent(S4, A)=S5, and S1, S4 are leaf suffix nodes.

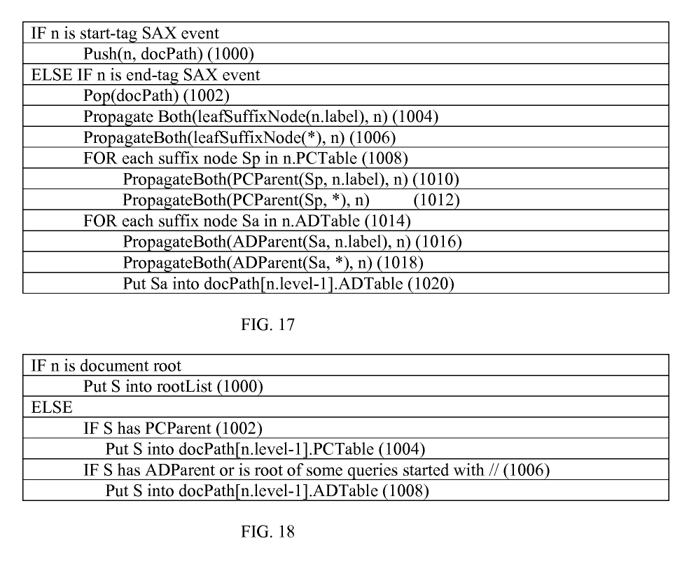

FIG. 17 depicts the NFA based bottom-up path matching algorithm. Here docPath is a stack that contains those document elements with only their start-tags being visited. When a start-tag SAX event is generated, the system pushes the document element into docPath (1000). When an end-tag SAX event is generated, the top document element is popped from the stack (1002). It further computes the suffix query nodes that n satisfies. First, those leaf suffix nodes with the matching labels (at most two such nodes in the shared suffix plan) are satisfied (1004, 1006). Next, other matching suffix nodes are computed based on n.PCTable and n.ADTable (1008, 1014), where n.PCTable contains all the suffix nodes {Sc} that are satisfied by n's children and n.ADTable contains all the suffix nodes {Sd} that are satisfied by n's descendants. All the matching suffix nodes need to be put into e.PCTable and e.ADTable, where e is n's parent (the propagateBoth procedure in FIG. 18). As an optimization, S is put to e.ADTable if S.ADParent is not empty or S is root of some queries started with “//” (1006). Similar optimization applies to e.PCTable (1004). Finally, the suffix nodes in n.ADTable need to be put into e.ADTable (1020 in FIG. 17).

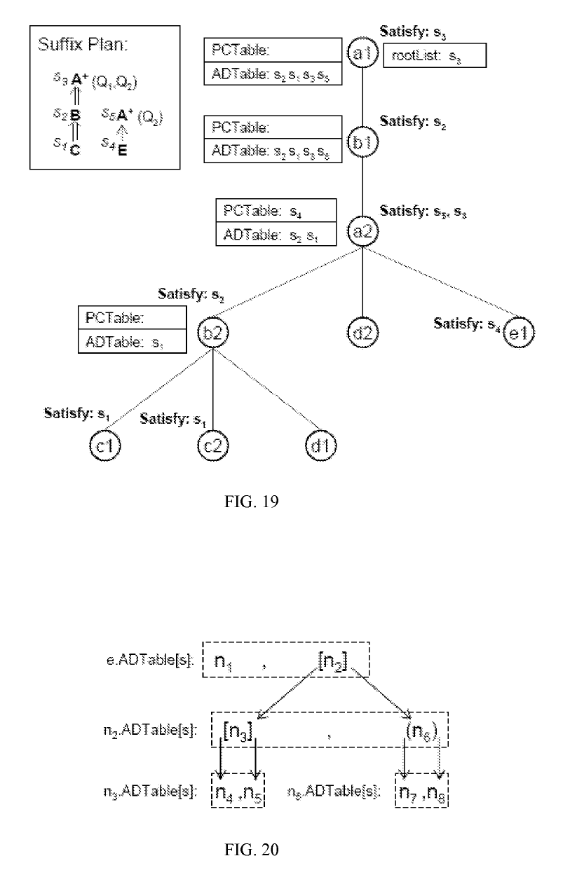

FIG. 19 describes a running example for processing the XML document (FIG. 1A) based on the shared plan in FIG. 16. First, c1 is processed. It only matches S1 since its PCTable and ADTable are empty. S1 is then put into b2.ADTable (not b2.PCTable since S1 only has AD parent). When visiting b2, since S1 is in b2.ADTable, S2 is satisfied. Now both S1 and S2 need to be put into a2.ADTable. Eventually, a1 satisfies S3, which will be put into rootList. Now the path queries rooted at S3 are satisfied. Also those queries rooted at S5 and started with “//” (S5 in a1.ADTable) are also satisfied.

One issue with the algorithm in FIGS. 17 and 18 is that it can only find those queries that are satisfied but cannot find the matching elements. This can be resolved by using the following result encoding scheme.

A matching tree for suffix query node S can be either n, (n//) or [n//]. Here n is a document element that satisfies S. (n//) denotes all n's descendant elements that satisfy S. [n//] combines the semantics of n and (n//). The difference between (n//) and [n//] is whether n satisfies the suffix node S or not. This encoding is called TOP encoding scheme.

The ADTable and PCTable are extended to also contain the matching elements. Here e.PCTable[S] denotes all e's child elements that satisfy the suffix node S and e.ADTable[S] denotes all e's descendant elements that satisfy S. FIG. 20 depicts one example how this TOP encoding scheme captures the AD relationship between the elements that satisfy the same query node. As can be seen, e has two matching trees that satisfy S, n1 and [n2], respectively. From [n2], there exists n2's descendants that also satisfy S, which can be found in n2.ADTable[S]={[n3],(n6)}. Here, n3 satisfies S while n6 not. Next, both [n3] and (n6) can be expanded further in a similar way. Finally, n1, n2, n3, n4, n5, n7, n8 are e's descendant elements that satisfy S.

Next, how the TOP encodings can be computed during path matching is discussed. The key idea is as follows. Assume that n's parent element is e. When n satisfies the suffix node S, the matching algorithm in FIGS. 17 and 18 will report S to e. In fact, the matching elements of S can be reported to e (in a TOP form) as well. Again, take FIG. 20 as one example. When visiting n3 in post-order, n3 satisfies S and its n3.ADTable[S] is not empty. In this case, the TOP encoding [n3] will be appended to n2.ADTable[S]. When visiting n6, n6 does not satisfy S but there are descendants of n6 that satisfy S. In this case, the TOP encoding (n6) will be appended to n2.ADTable[S]. An alternative is to copy every tree in n6.ADTable[S] into n2.ADTable[S]. This however may not be efficient since n6.ADTable[S] could contain an arbitrary long list.

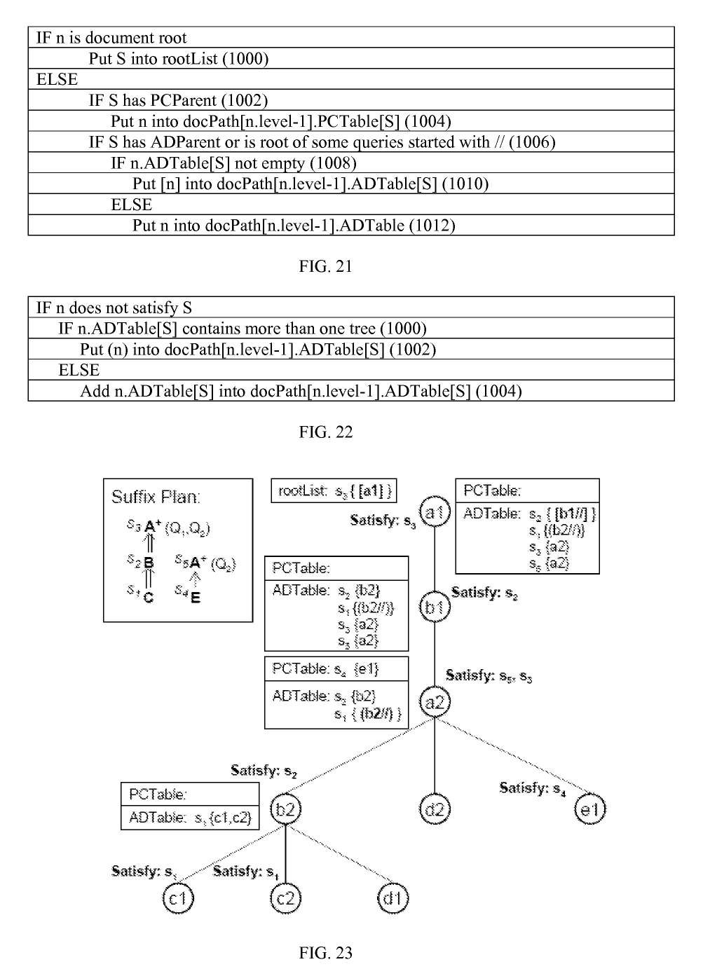

FIG. 21 depicts the details how the TOP encoding scheme can be piggybacked into the path matching algorithm. Assume that n's parent element is e. If n satisfies S, first, it will be appended to e.PCTable[S]. Next, if n.ADTable[S] is not empty, then [n//] would be appended into e.ADTable[S]. Otherwise, n would be appended to e.ADTable[S]. Finally, the content in n.ADTable[S] will be appended into e.ADTable[S] as well (FIG. 22). If n.ADTable[S] contains more than one matching tree, then only (n//) would be put into e.ADTable[S] rather than copying all these trees. This procedure will replace the statement 1020 in FIG. 17.

Let's re-consider the running example in FIG. 19 when the TOP encoding scheme is piggybacked into the matching algorithm. As can be seen in FIG. 23, when visiting b2, since b2.ADTable[S1] contains more than one matching tree, (b2//) will be put into a2.ADTable[S1]. When visiting b1, since it satisfies S2 and b1.ADTable[S2] is not empty, [b1//] will be appended into a1.ADTable[S2]. This means that both b1 and its descendants in b1.ADTable[S2] satisfy S2.

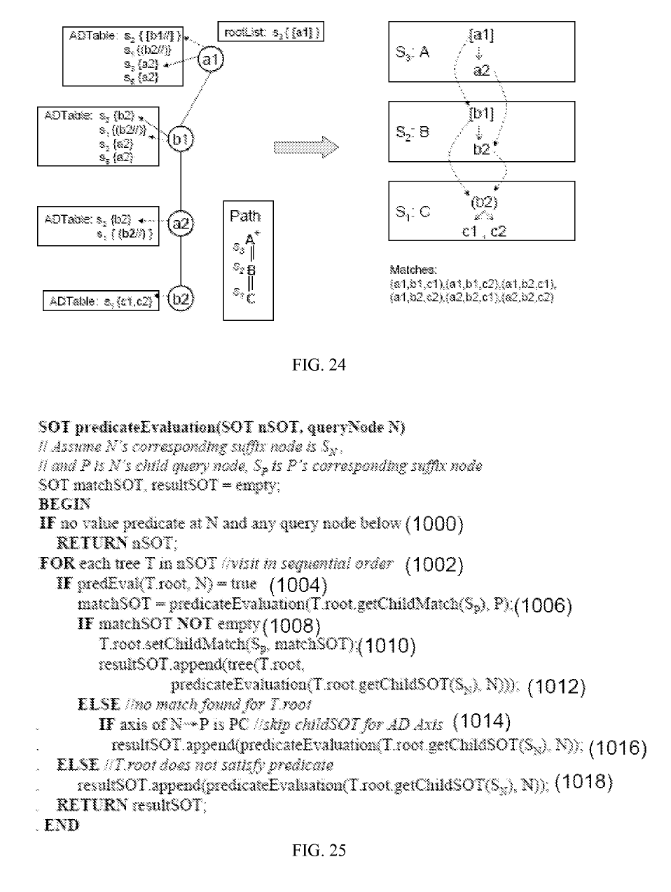

FIG. 24 shows how the results of path query //A//B//C are compactly encoded. Here the dotted edges represent the matching elements w.r.t one query step, while the solid edges represent the expansion of the matching trees. Both a1 and a2 satisfy S3. The matches w.r.t their child node S2 are a1.ADTable[S2]={[b1//]}={b1,b2} and a2.ADTable[S2]={b2}, respectively. Similarly, b1.ADTable[S1] and b2.ADTable[S1] further provide the matches to their child query node S1. The right side of the figure provides a clearer view of how the total 6 path matches are compactly encoded.

Next, the post processing engine in FIG. 2A is discussed. The matching trees in either e.PCTable[N] or e.ADTable[N] are in document order, which is called Sequence of Trees (SOT) structure, i.e., a sequence of TOP trees.

First, the value-based predicate evaluation over TOP encodings is discussed. Let's re-consider Q1 in FIG. 1A. By the path matching and encoding scheme described in FIGS. 17, 18, 21 and 22, a compact representation of all the path matches is obtained as shown in FIG. 24. Now in order to evaluate the predicate “A[id=1]”, instead of checking the predicate for all 6 path matches, the system checks a1 and a2 (from “[a1]”) only once. The results implicitly carry over all 6 path matches.

FIG. 25 depicts the algorithm for predicate evaluation over the encoded path matches. It returns the satisfied path matches also in the same compact form, which will be used for subsequent path joins if there are any. In XML filtering scenario, when only whether the query is satisfied or not is interested, this algorithm can be tuned to stop earlier whenever a matching is found. The input to the algorithm are the elements that satisfy the root query node in a Sequence of Trees (SOT) form, such as [a1//] in previous example. Then it will evaluate the value predicate (if any) to each of the element in the SOT (1004). If the element satisfies the condition, it will go further down to evaluate the child query node P (1006). (1010) is to update n's child matches w.r.t one query step. The statement (1012) maintains the output tree structure. There is a chance to skip the entire sub-tree in the case of AD axis (1014 and 1016). Take the path query “//A//B[id=1]//C” for example. If the system finds that a1 does not have any path matches that satisfy the predicate, the system can skip all a1's descendants, i.e, a2 in this case. The reason is that the path matches below a2 must be a subset of those below a1.

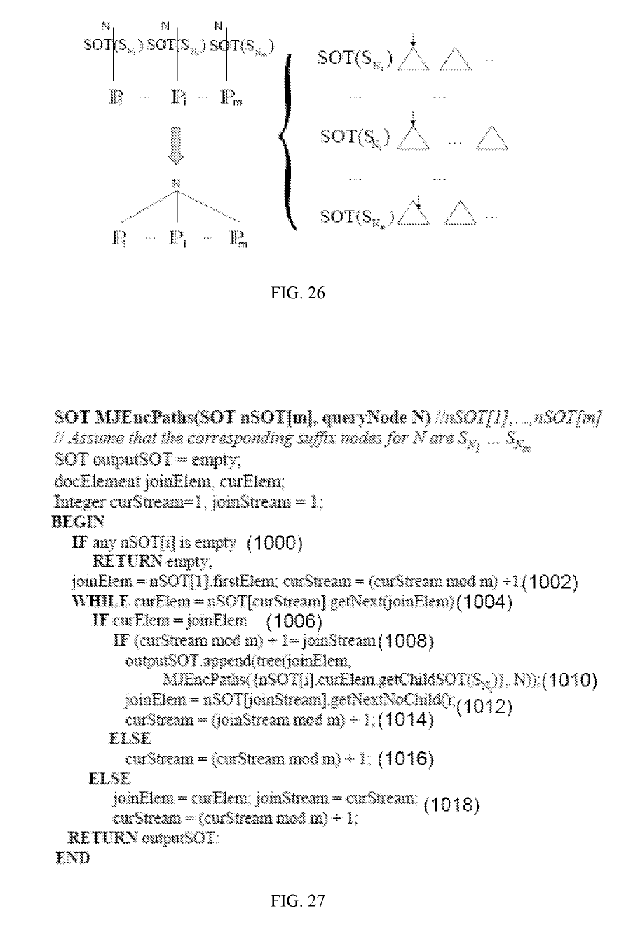

Second, the method for path joins over TOP encodings is discussed with m encoded path matches P1, . . . , Pm. The matching SOTs of the root node N for each path are SOT(SN1), . . . , SOT(SNm), respectively, as shown in FIG. 26. Now these paths need to be joined together at their root node N. For this, the system only needs to perform joins over these SOTs to find those elements that appear in each SOT. Performing joins over these SOTs instead of over the full path matches provides the following two benefits. First, the elements in each SOT are duplicate-free. This avoids any redundant join probes as described earlier. Second, the elements in SOT are already sorted in document order. Hence the system can apply an efficient merge join algorithm to merge multiple SOTs. Such merge join is applicable even when the document is recursive, a feature that is not available if the join is operated over the full path matches. As a simple example, when processing Q2 in FIG. 1A, the two SOTs to be joined are [a1//] and a2, respectively. Only two join probes are necessary.

The detail of multi-way join over encoded paths is described in FIG. 27. The algorithm takes multiple SOTs as input and outputs the matches also in an SOT form. The system maintains a cursor for each SOT (1002). Here the getNext(joinElem) operation (1004) moves the cursor in order to find a match. In particular, given a candidate element n, the system moves the cursor at SOT(SNi) until either a matching is found or an element after n in document order is found. It is possible to skip the entire sub-tree when moving the cursor. Assume that the cursor currently points to an element e. If e is before n in document order and has no AD relationship with n (by checking their region encodings dynamically assigned in XML streams), the system can skip the entire sub-tree of e, since none of e's descendants can be n. The statement (1010) is to create an output tree.

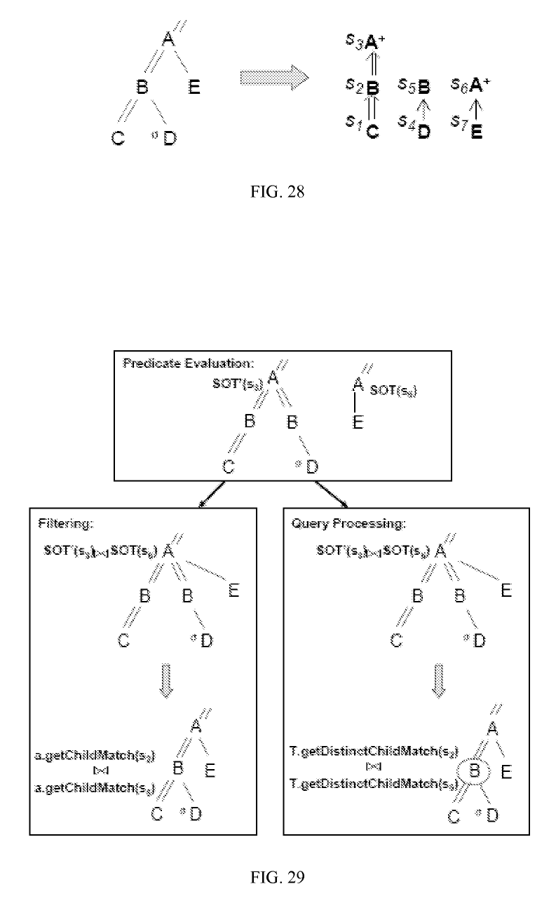

Put together, the complete methods for filtering and processing of tree pattern queries are discussed. As a first step, the system decomposes the twig query into a set of paths. Instead of creating full path for each leaf node, the system also exploits the prefix sharing within the same twig query. That is, when the system enumerates the leaf to root path, the system stops if the current query node has already been enumerated for other paths. Take the twig query in FIG. 28 for example. The system only needs to match the partial path “//B/D” instead of the full path “//A//B/D”. The matches for “//A//B/D” can be obtained as follows. For any element a that satisfies S3, whether it also has matches for “//A//B/D” or not can be determined by checking a.getChildMatch(S5) (i.e., a.ADTable[S5]). Then the path matches for “//A//B/D” are obtained only for those A elements that also have “//A//B//C” matches. The benefits of this decomposition method are two-folds. First, the path matching cost is reduced. Second, for joining of any two paths, the system only needs to perform a single join at their branch query node rather than once for each of their common prefix query node. The number of joins required for the entire twig query thus equals to the number of branch nodes.

Next, the filtering algorithm is discussed. Two heuristics are exploited. The first one is the common predicate pushdown before any joins. The second one is that the path join is done at each branch node in a top-down manner. This heuristics is based on the fact that the join elimination of an element at higher level could possibly eliminate many path matches. The left side of FIG. 29 describes one example how the twig query in FIG. 28 can be filtered. First, the predicate on D is evaluated. To achieve this, as mentioned earlier, for each A element in SOT(S3), the system obtains the path matches for “//A//B/D” and evaluate the predicate using the algorithm in FIG. 25. The system denotes SOT′(S3) as the resulting A elements that have matches for both “//A//B//C” and “//A//B/D[σ]”. Next, the path joins are evaluated at each branch node. First, SOT′[S3] is joined with SOT[S6] for branch node A. For each join result a, the system obtains the corresponding matching B elements for path “/A//B//C” and “//A//B/D[σ]”, i.e., a.getChildMatch(S2) and a.getChildMatch(S5). These two SOTs are joined further for branch node B. The whole process ends as soon as one join result for B is found, i.e., there exists one match to the entire twig query.

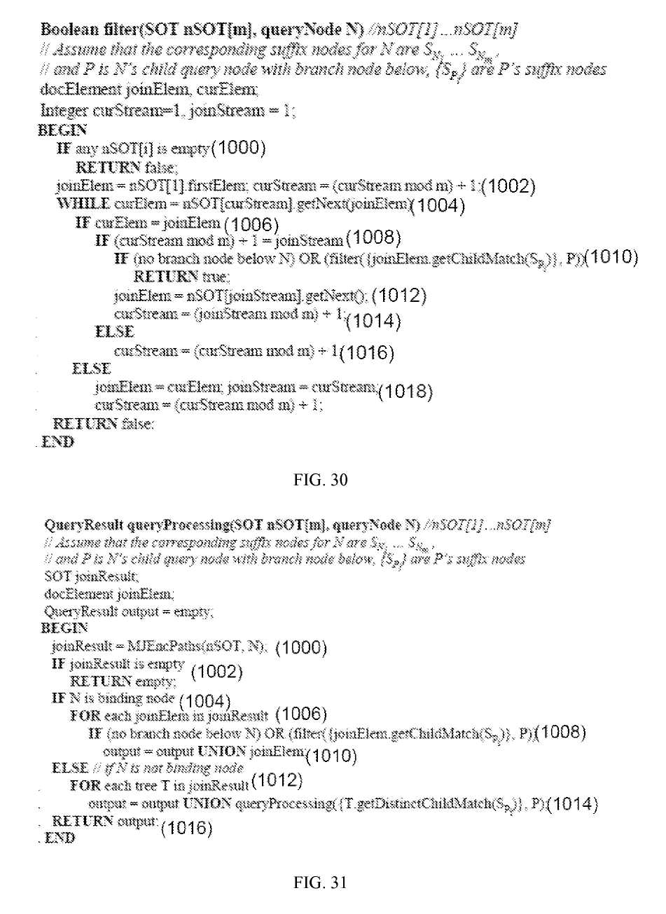

FIG. 30 depicts the details of the filtering algorithm (the top-down join evaluation part). The algorithm is quite similar to the merge join algorithm in FIG. 27. The main difference is at (1010): when a join result is found, the system traverses down the tree query and evaluate the joins for the branch nodes below if there are any. This way, the system can stop earlier whenever a match to the entire query is found.

The advantages of the above encoded path based filtering solution compared to the existing work based on the full path matches, such as YFilter are discussed. The first benefit of our approach comes from the predicate evaluation. The second benefit comes from the join processing. In particular, all the joins evaluated in our framework are duplicate free and merge join based. Furthermore, the scope of the join at any non-root branch node is also limited with respect to their parent element, e.g., a.getChildMatch(S2) and a.getChildMatch(S5). Third, the system avoids enumerating any full path matches, which is a non-trivial cost.

The right side of FIG. 29 depicts how the sample query is processed when B is the binding node, i.e., the matches have to be returned. For this, distinct B elements are obtained for each tree T in the join result of node A. Here T.getDistinctChildMatch(S2) and T.getDistinctChildMatch(S5) are to consider only T's root element. This way, the duplicates of B elements can be avoided.

FIG. 31 depicts the query processing algorithm for a single binding node. When the current query node N is a binding node (1004), the system considers each element in the SOT one by one (1006). When the current query node N is a not binding node, the system instead considers the entire tree in the SOT and gets the distinct matches over its child query node (1012 and 1014). A similar idea can be applied to extend this algorithm to support multiple binding nodes, i.e., Generalized-Tree-Pattern, as required by XQuery. When N is a group binding node, which is a common operation for XQuery, the joinResult in (1000) contains all the elements that need to be grouped together. Compared to the query processing approach based on full path matches, this method avoids the potentially expensive duplicate elimination, sort and grouping operations.

Next, an evaluation between AFilter, ForestFilter and state-of-the-art XML filtering algorithm YFilter is discussed. YFilter employs a top-down NFA for path matching and evaluate predicates, path joins during post-processing based on full path matches.

The query generator in YFilter test suite is used. The default setting is depth=6, probability of “*”=0.1, probability of “//”=0.2, number of value predicates=0, number of branches=0 and distinct=TRUE. All the value predicates are equality conditions over integers between 1 and 100.

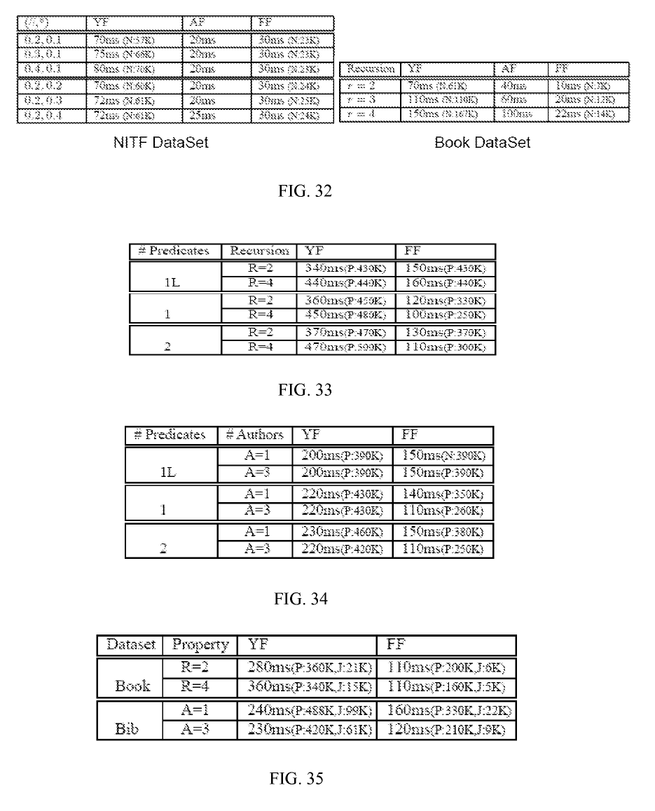

First, the filtering of path queries is discussed. A total of 50,000 path queries are generated for NITF dataset. The system varies the probability of // and * during query generation and investigate how that affects the filtering performance. FIG. 32 depicts the results, where “N:number” is the number of the NFA transitions for YFilter (YF) and ForestFilter (FF). AFilter (AF) is a stateless approach thus does not have any NFA transitions. As can be seen, ForestFilter is much less sensitive to the increasing “//” than YFilter, since the number of ε-transitions for ForestFilter is bounded to the document path as opposed to the entire subtree for YFilter. Increasing the likelihood of occurrence of “*” does not affect both algorithms much. AFilter performs faster than ForestFilter over this dataset. The reason is that the path selectivity is very high for NITF dataset. Since AFilter employs a more stringent triggering mechanism, i.e., leaf query step rather than leaf query node, less computation is required. Next, a Book, which is a recursive dataset, is considered. Only 2500 distinct queries can be generated due to its extremely small DTD. In this experiment, the system varies the maximum recursive depth of the XML document from 2 to 4. FIG. 32 depicts the results. The cost of YFilter increases significantly when the maximum recursion increases. This is due to the excessive (theoretically exponential) number of prefix matches for recursive dataset, which consequently introduces a large number of ε-transitions. In comparison, ForestFilter performs much better (more than 6 times faster) due to the bounded ε-transitions. For this dataset, AFilter becomes slower than ForestFilter. The reason is that since the path selectivity is low, the leaf query step trigger condition is no longer effective. Furthermore, AFilter needs to traverse the common document prefix multiple times. Although the matching can be saved in prefix cache to avoid repetitive matching, the corresponding caching cost is still non-trivial.

Next, the performance on post processing is reported. First is the value predicate evaluation over path queries. For the Book dataset, the system also varies the maximum recursion of the XML document from 2 to 4 (without changing the document size). FIG. 33 depicts the results. Here “1L” means one predicate at the leaf query node and “P:number” is the number of predicates evaluated. As can be seen, when the predicates are all at the leaf query node, the number of predicates evaluated is similar for both YFilter and ForestFilter. The performance benefit primarily comes from path matching and avoiding enumerating any path matches. When the value predicates are randomly generated, i.e., some are at non-leaf nodes, ForestFilter significantly reduces the number of predicate evaluations. The reason is that the elements that match the higher level query nodes have high redundancy in the path matches. ForestFilter helps address such redundant predicate evaluation problem. Also when the maximum recursion in the document is high, YFilter increases the filtering cost since more path matches are found. In comparison, ForestFilter essentially reduces the cost. This is due to its pruning power for eliminating the entire sub-tree when evaluating predicates. In those experiments, the enumeration of full path matches, which is required by YFilter for post-processing also introduces significant overhead. Next, for the Bib dataset, the system also varies the average number of authors per publication from 1 to 3 (without changing the document size). The latter is more common in practice. FIG. 34 depicts the results. As can be seen, first, when all the predicates are at the query leaf nodes, both approaches evaluate same number of predicates. This is similar to the Book case. When the predicates are randomly placed at the query nodes, ForestFilter reduces the number of predicate evaluations. When there are 3 authors per publication, ForestFilter saves even more redundant predicate evaluations. In comparsion, YFilter does not have such capabilities.

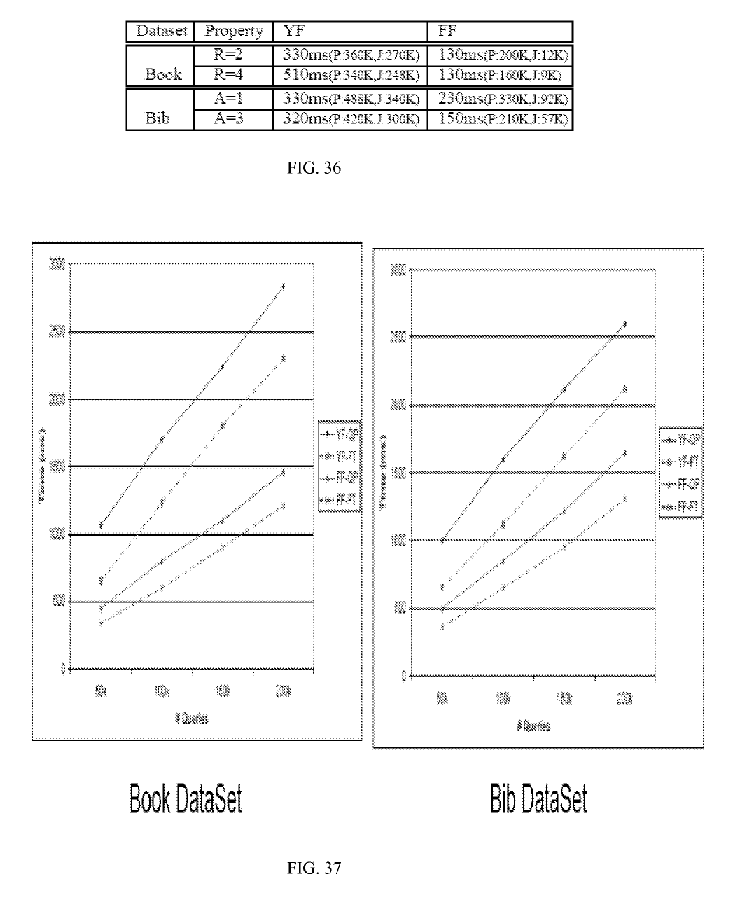

Second is the performance on filtering of twig queries. Total 10,000 twig queries are generated for both Book and Bib datasets, with average 3 branches and 2 value predicates per query. FIG. 35 depicts the results, where “P:number, J:number” reports the number of predicate evaluations and join probes, respectively. As can be seen, similar behaviors are observed. ForestFilter introduces much less predicate evaluations and join probes. The saving is enlarged when the maximum recursion increases or the number of authors per publication increases. The same query workload is re-run by turning the output option to return all the results (single binding node, XPath case). DTD is assumed to be available to YFilter such that it can choose the best join method. For Bib dataset, YFilter uses merge join since Bib is non-recursive. For recursive Book dataset, YFilter has to use the hash join method. For ForestFilter, the merge join based encoded path join algorithm always works even under recursive dataset. FIG. 36 depicts the results. As can be seen, compared to the filtering case (FIG. 35), query processing requires significantly more join probes since all the matches have to be found. Since ForestFilter saves large number of join probes, it is able to boost the performance even further.

Next, the results on the scalability of ForestFilter algorithm are reported. The system varies the number of queries from 50,000 to 200,000, with average 3 branches and 2 predicates per query. For the Book dataset, the maximum recursion is 4. For the Bib dataset, the average number of authors per publication is 3. FIG. 37 depicts the result. Here the solid lines denote the query processing cost, while the dotted lines denote the filtering cost. As can be seen, both algorithms scale linearly in terms of the number of queries. ForestFilter performs about 2 times faster than YFilter in terms of both filtering and query processing performance. For these experiments, the performance gain is determined by how many predicate evaluations and join probes ForestFilter can save (the saving from path matching and path result enumeration is no longer significant compared to the total cost).

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to provide an adaptable path expression filter, comprising:
indexing one or more registered pattern expressions with a linear size data structure;
representing at least one root-to-leaf path with a runtime stack-based data structure (StackFab); and
storing one or more prefix sub-matches in a cache for reuse.

2. The method of claim 1, comprising filtering path expressions of type P^{{//,//,*}.}

3. The method of claim 1, wherein the StackFab contains one stack per symbol.

4. The method of claim 1, comprising building the StackFab based on one or more step commonalities between path expressions during a pre-order traversal of an XML document.

5. The method of claim 1, comprising using one or more leaf steps in the path expressions as trigger conditions.

6. The method of claim 1, comprising traversing back one or more links in the StackFab to compute individual path matches once the trigger conditions are detected.

7. The method of claim 1, comprising clustered traversing back by exploiting suffix commonalities between path expressions.

8. The method of claim 1, comprising avoiding repetitive traversals by caching a result of a common prefix among one or more path expressions.

9. The method of claim 1, comprising
clustered traversing back by exploiting suffix commonalities between path expressions;
avoiding repetitive traversals by caching a result of a common prefix among one or more path expressions; and
performing early and late unfolding of a suffix based cluster.

10. A method to filter one or more path expressions, comprising:
applying an NFA (non-deterministic finite state automata) to filter the one or more path expressions;
performing a post-order traversal of an XML document tree; and
exploiting one or more suffix commonalities among the one or more path expressions.

11. The method of claim 10, comprising filtering path expressions of type P^{{//,//,*}.}

12. The method of claim 10, comprising bottom up path matching based on non-deterministic finite state automaton.

13. The method of claim 10, comprising performing shared (common document prefix) path matching through post-order document traversal.

14. The method of claim 10, comprising performing shared (multiple path expressions) path matching by exploiting the suffix commonalities between path expressions.

15. A method to determine one or more compact path matches, comprising:
using a compact tree encoding scheme to represent one or more path matches for an XML document; and
computing the compact encoding scheme when filtering the path expression using an NFA (non-deterministic finite state automata).

16. The method of claim 15, comprising filtering the path expression using an NFA (non-deterministic finite state automata) through a post-order traversal of an XML document tree.

17. The method of claim 16, comprising associating a PCTable and an ADTable with each document element, the document element having a list of tree encodings.

18. The method of claim 17, comprising propagating tree encodings in the PCTable and ADTable to those of the parent element.

19. A method to process a complex query using tree encoding, comprising:
filtering the tree pattern query; and
processing the generalized tree pattern queries based on the tree encoding.

20. The method of claim 19, comprising filtering tree pattern queries.

21. The method of claim 19, comprising processing a generalized-tree-pattern query containing a mixture of a binding node, a non-binding node and a group binding node.

22. The method of claim 19, comprising evaluating one or more value predicates over tree encodings.

23. The method of claim 19, comprising performing a merge join based method for evaluating path joins over tree encodings.

24. The method of claim 20, comprising performing a top-down filtering of tree pattern queries with early termination.

25. The method of claim 21, wherein the query processing method of generalized tree pattern queries is top-down.
